(19) United States
(12) Patent Application Publication
(10) Pub. No.: US 2011/0000009 A1
(43) Pub. Date: Jan. 6, 2011

(54) EXTERNAL POCKET FOR A PROTECTIVE SUIT

(76) Inventors: E. Alan Culpepper, Adelphi, MD (US); Mary L. Jones, Rockville, MD (US)

Correspondence Address: BACON & THOMAS, PLLC, 625 SLATERS LANE, FOURTH FLOOR, ALEXANDRIA, VA, 22314-1176, US

(21) Appl. No.: 12/825,760

(22) Filed: Jun. 29, 2010

Related U.S. Application Data
(60) Provisional application No. 61/222,655, filed on Jul. 2, 2009.

(51) Int. Cl. A62B 17/00; A41D 27/20

(52) U.S. Cl. 2/457; 2/247

(57) ABSTRACT

A protective suit is disclosed which comprises an external pocket that is adapted to receive and releasably retain at least one decontamination product, such as a wipe in a sealed envelope, and to avoid collecting any liquid such as a wash liquid that may be used to decontaminate the suit. The external pocket is configured such that the opening of the pocket is pointing directly down, or at an angle that is less than about horizontal, when the person wearing the suit stands on a generally horizontal surface.

### TECHNICAL FIELD OF THE INVENTION

The technical field of the invention is protective suits for use in a hazardous environment. The suits include chemical protective suits, biological protective suits, and combined chemical and biological protective suits. The suits are for humans to wear. The suits may be designed for a singe use, or for multiple uses. The wearers include first responders who are typically the first persons to reach the scene of a disaster or attack. The hazardous environments include those where chemicals and/or biological agents are present in sufficient concentration to be likely to be injurious or fatal to humans. The first responders may respond to the site of a disaster or attack where there are injured humans who need decontamination as soon as possible to increase the likelihood that they will survive their injuries, or that the impact of their injuries will be less severe. The decontamination of such injured humans may allow them to be treated at conventional sites such as triage areas and hospitals, as compared to specialized sites that designed to contain adverse agents such as chemical toxins and biological warfare agents.

The first responders may be provided with a broad spectrum skin decontamination product, such as decontamination wipe in a sealed envelope. The decontamination wipe may be used to wipe the skin of victims of a chemical or biological accident or attack, and thereby clean the skin of harmful chemical and biological agents. After a wipe is used to clean the skin, the used wipe may be disposed of by placing them into a waste bag.

The decontamination wipe may be RSDL which is a broad-spectrum skin decontamination product that was developed to remove or neutralize chemical warfare (CW) agents and/or T2 toxin from the skin. Such a decontamination wipe may be used by members of the military, or to homeland security organizations such a police, fire and rescue units, and other first responders including medical personnel in hospital emergency rooms and in triage areas.

The first responders must be decontaminated after they leave the area that is contaminated with the harmful chemical and/or biological agents. The decontamination is usually a multi-step procedure. The first step may be a wash where a liquid is sprayed on or poured over the exterior of the first responder in the protective suit to wash off any harmful chemical and/or biological agents. The liquid used to wash the suit may contain harmful chemical and/or biological agents, and would be disposed of in an appropriate manner. This may be followed by a second step of scrubbing where the surface of the protective suit is scrubbed with a scrubber to remove any harmful chemical and/or biological agents. The scrubber used to scrub the suit may contain harmful chemical and/or biological agents, and would be disposed of in an appropriate manner. This may be followed by removal of the protective suit from the first responder. The protective suit may be disposed of, or re-used depending on the design of the suit.

### DESCRIPTION OF PRIOR ART

The prior art includes protective suits in various configurations. Some suit are provided with an integral hood or helmet. Other suits may have a collar that is adapted to receive a hood or helmet. Some suits are provided with integral gloves, while other suits have cuffs that adapted to receive gloves. Some suits have a closure that is adapted close a vertical opening which extends from the collar to the waistband. Other suits have a closure that is adapted close a vertical opening which extends left shoulder to the right thigh. The closure may be adapted for one time use, or for multiple uses. The suits are made of a flexible material, or materials, which are impervious to selected chemical and biological agents. The material or materials should be thin and light (low weight) enough to allow the wearer to move easily, while thick enough to avoid puncture or other compromise that could expose the wearer to harmful chemical or biological agents.

### SUMMARY OF THE INVENTION

The present invention is an external pocket for a protective suit. The external pocket is adapted to receive at least one decontamination wipe in a sealed envelope, to retain the sealed envelope in location that provides easy access for removal, and to release the sealed envelope when it is removed from the pocket by the wearer of the protective suit, and an adjacent first responder. The external pocket is adapted to avoid collecting liquids such as the wash liquid that may be used to decontaminate the suit. A preferred configuration of the external pocket is such that the opening of the pocket is toward the bottom of the person wearing the protective suit. The opening may be pointing directly down, or at an angle that is less than about horizontal as the person wearing the suit stands on a generally horizontal surface. This surface may be the ground, or the floor of a washing area for decontamination, or another surface. A preferred location of the external pocket is the front chest area of the protective suit, or another location on the suit, helmet and/or hood which is accessible to the person wearing the suit or to an adjacent person. The external pocket is preferably attached to the protective suit by welding. The external pocket may be glued to the protective suit. The external pocket should not be sewn to the protective suit because this may compromise the integrity of the suit and allow harmful chemical and biological agents and other contaminants into the suit and into contact with the person wearing the suit.

### DESCRIPTION OF THE DRAWINGS

FIG. 1 is a photograph of the front of a protective suit according to the present invention.

FIG. 2 is a photograph of an external pocket for a protective suit according to the present invention.

FIG. 3 is a photograph of the opening of an external pocket for a protective suit according to the present invention.

### DETAILED DESCRIPTION OF THE INVENTION

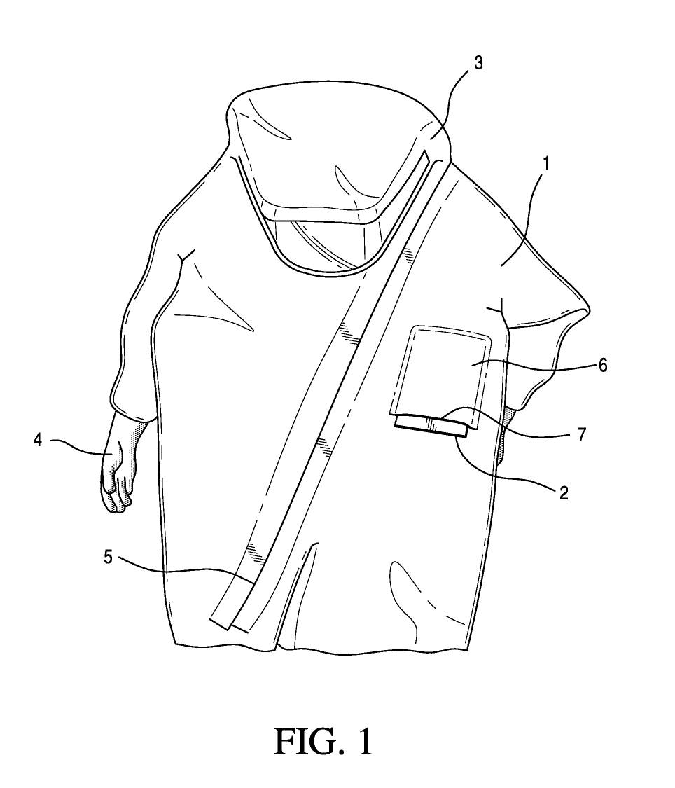

Referring now to FIG. 1 of the drawings, a protective suit according to the present invention is shown. Protective suit 1 comprises collar 3, closure 5, and external pocket 6. A right glove 4 is shown attached to the right arm of protective suit 1. The terminus of the left arm of protective suit 1 is not shown. The legs of protective suit 1 are not shown. Closure 5 extends in a generally diagonal direction from the left shoulder to the upper right thigh of protective suit 1. Closure 5 is adapted to be opened and allow an individual to put on the protective suit. After the individual puts on the protective suit, closure 5 is adapted to be closed and seal off the individual from the environment surrounding the protective suit 1. External pocket 6 is in a generally rectangular configuration and adapted to receive sealed envelope 2 of a generally rectangular configuration. Sealed envelope 2 contains a decontamination wipe or other broad-spectrum skin decontamination product. In this embodiment of the invention, the dimensions of external pocket 6 are close enough to the dimensions of sealed envelope 2 so that sealed envelope 2 is retained in external pocket 6 until someone pulls down on sealed envelope 2 in order to remove it from external pocket 6. External pocket 6 in this embodiment is shown in a configuration with the opening 7 of external pocket 6 in a generally downward position, so that a person wearing protective suit 1 and standing on a generally horizontal surface would position opening 7 at an angle of about 90 degrees versus the surface on which the individual is standing. In another embodiment of this invention, the angle may be varied up to about 45 degrees. In still another embodiment of the invention, this angle may be varied up to about 5 degrees. It is preferred that the opening of the external pocket not be perpendicular to the ground, or pointing upward, so as to avoid the collection of wash liquid in the external pocket.

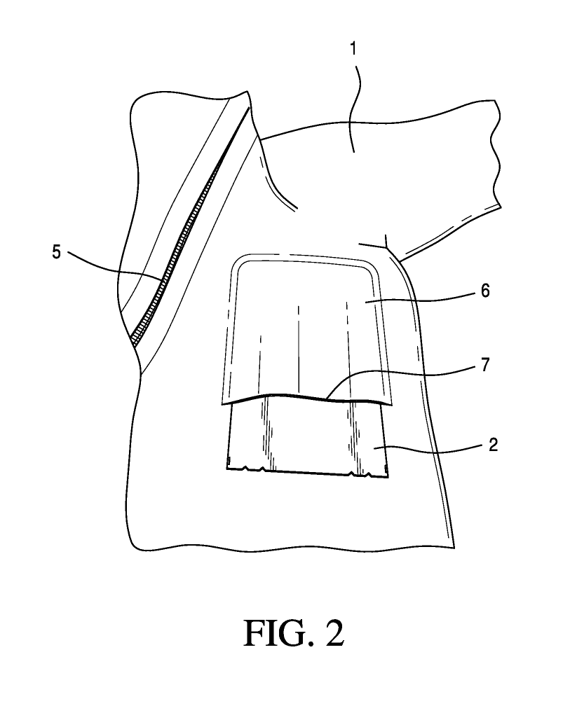

Referring now to FIG. 2 of the drawings, an external pocket 6 on protective suit 1 according to the present invention is shown. Protective suit 1 is provided with closure 5. Sealed envelope 2 is shown extending from opening 7 of external pocket 6. Sealed envelope 2 is releasably retained in external pocket 6 because the shape of external pocket 6 is close to the shape of sealed envelope 2. In another embodiment, sealed envelope 2 may be retained in external pocket 6 by other means, which may include a clip or the like. In yet another embodiment, sealed envelope 2 may retained in external pocket 6 by a hook and loop type fastener.

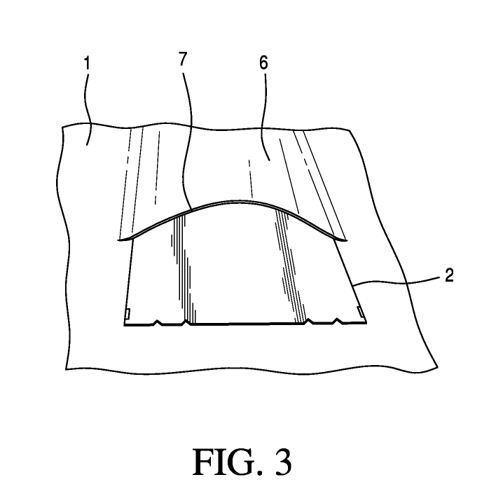

Referring now to FIG. 3 of the drawings, external pocket 6 according to the present invention is shown in protective suit 1. The opening 7 of external pocket 6 contains sealed envelope 2. The opening 7 of external pocket 6 is shown being held open by the finger of an individual.

It will be apparent to those skilled in the art that various changes and modification may be made to the invention as described herein without departing from the spirit of the invention.

We claim:

1. A protective suit comprising an external pocket with a pocket opening that is pointing directly down.

2. The protective suit of claim 1, wherein said external pocket is adapted to releasably retain a decontamination product.

3. The protective suit of claim 2, wherein said decontamination product is a sealed envelope.

4. The protective suit of claim 3, wherein said sealed envelope contains at least one decontamination wipe.

5. A protective suit comprising an external pocket with a pocket opening that is pointing at an angle that is less than about horizontal.

6. The protective suit of claim 5, wherein said external pocket is adapted to releasably retain a decontamination product.

7. The protective suit of claim 6, wherein said decontamination product is a sealed envelope.

8. The protective suit of claim 7, wherein said sealed envelope contains at least one decontamination wipe.
